(19) United States
(12) Patent Application Publication
(10) Pub. No.: US 2026/0143374 A1
(43) Pub. Date: May 21, 2026

(54) METHOD PERFORMED BY USER EQUIPMENT, AND USER EQUIPMENT

(71) Applicant: SHARP KABUSHIKI KAISHA, Sakai City, Osaka (JP)

(72) Inventors: CHONGMING ZHANG, Shanghai (CN); RENMAO LIU, Shanghai (CN)

(21) Appl. No.: 19/114,534

(22) PCT Filed: Sep. 25, 2023
(86) PCT No.: PCT/CN2023/121028

§ 371 Date: Mar. 24, 2025

(30) Foreign Application Priority Data
Sep. 26, 2022 (CN) 202211178133.9

(51) Int. Cl. H04W 24/10; H04W 88/04

(52) U.S. Cl. CPC H04W 24/10; H04W 88/04

(57) ABSTRACT

The present invention provides a method performed by a user equipment and a user equipment. The method comprises: receiving, by a remote UE, a notification message from a relay UE, the notification message including an information element having a value of content of a system information block (SIB1); and in the case of receiving the notification message, determining, by the remote UE, whether the remote UE itself is configured with multi-path, wherein in the case of not being configured with multi-path, the remote UE applies SIB1, and in the case of being configured with multi-path, the remote UE determines, according to a result of further determination, whether to apply SIB1. Thus, a serving cell can be appropriately determined, and the communication quality and the communication efficiency can be improved.

### TECHNICAL FIELD

The present invention relates to the technical field of wireless communications. More specifically, the present invention relates to a method performed by a user equipment, and a corresponding user equipment.

### BACKGROUND ART

In a cell covered by a base station, a user equipment (UE) can directly communicate with the base station, and such a communication connection is called a direct connection. The UE may also be in communication connection with the base station via a relay UE, and such a connection may be referred to as an indirect connection. In a scenario in which the UE communicates with the base station by means of the relay UE, the UE is called a remote UE.

The remote UE may operate in a mode in which there is only an indirect connection, and such a mode may be referred to as a single-path communication mode. In addition, in order to improve uplink and downlink transmission rates and throughput of the UE, the UE may further simultaneously operate in a direct connection mode and an indirect connection mode. As shown in FIG. 1, in such an operating mode, the UE and the base station communicate with each other via different paths, so that the operating mode may also be referred to as a multi-path communication mode/communication mode with multiple paths.

In FIG. 1, a wireless communication mode is typically adopted between a remote UE and a base station and between a relay UE and the base station, for example, communication techniques and means such as 5G NR or LTE. Moreover, the remote UE and the relay UE may communicate with each other on the basis of a sidelink communication mode, or a Wi-Fi communication mode based on hotspot coverage, or a wired connection mode.

In the prior art, when the relay UE acquires an updated SIB1 from the base station, the relay UE will always submit the updated SIB1 to the remote UE connected thereto. In the single-path communication mode, this is necessary so that the remote UE may promptly obtain SIB1 of a serving cell. However, in the multi-path communication mode, the relay UE may set up a connection with the base station at a Uu interface in cell A, while the remote UE may set up a direct connection with the same base station at the Uu interface in cell B, and there then exists an indirect connection between the relay UE and the remote UE. In such a scenario, the remote UE may obtain SIB1 of cell B from the base station and may then obtain SIB1 of cell A from the relay UE, causing confusion for the remote UE when determining a serving cell. How to avoid such confusion is a problem that needs to be solved.

### SUMMARY OF THE INVENTION

To solve the above problem, the present invention provides a method performed by a user equipment (UE) and a UE, which can avoid confusion caused for the UE when determining a serving cell even when communication is performed between the UE and a base station on the basis of a multi-path communication mode, so that a serving cell can be appropriately determined, and the communication quality and the communication efficiency can be improved.

According to an aspect of the present invention, provided is a method performed by user equipment (UE), comprising: receiving, by a remote UE, a notification message from a relay UE, the notification message including an information element having a value of content of a system information block (SIB1); and in the case of receiving the notification message, determining, by the remote UE, whether the remote UE itself is configured with multi-path, wherein in the case of not being configured with multi-path, the remote UE applies SIB1, and in the case of being configured with multi-path, the remote UE determines, according to a result of further determination, whether to apply SIB1.

According to another aspect of the present invention, provided is a user equipment, comprising: a processor; and a memory storing instructions, wherein the instructions, when run by the processor, perform the method described above.

### Effect of Invention

According to the method performed by the user equipment (UE) and the corresponding UE related to the present invention, since the obtained SIB1 is not directly applied when the multiple paths are configured, and whether to apply SIB1 is determined according to the result of the determination, even when communication is performed between the UE and the base station on the basis of the multi-path communication mode, the confusion caused for the UE when determining a serving cell can be avoided, so that the serving cell can be appropriately determined, and the communication quality and the communication efficiency can be improved.

### BRIEF DESCRIPTION OF THE DRAWINGS

FIG. 1 is a schematic diagram showing an operating mode (multi-path) in which a direct connection and an indirect connection are parallel, i.e., a multi-path communication mode.

FIG. 2 is a schematic diagram showing UE-to-network relay.

FIG. 3 is a schematic diagram showing protocol layer structures of an SRB and a split SRB.

FIG. 4 is a flowchart showing a method executed by a user equipment (UE) according to an embodiment of the present invention.

FIG. 5 is a simplified structural block diagram of a user equipment according to the present invention.

### DETAILED DESCRIPTION OF PREFERRED EMBODIMENTS

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

Prior to the specific description, several terms mentioned in the present invention are illustrated as follows. The terms involved in the present invention shall have the meanings set forth below, unless otherwise indicated.

UE: User Equipment;

NR: New Radio;

LTE: Long Term Evolution;

eLTE: enhanced Long Term Evolution;

RRC: Radio Resource Control;

MAC: Medium Access Control (layer);

MAC CE: MAC Control Element;

SDAP: Service Data Adaptation Protocol;

SRAP: Sidelink Relay Adaptation Protocol;

RLC: Radio Link Control;

PDCP: Packet Data Convergence Protocol;

ADAPT: adaptation layer;

PHY: physical layer;

RB: radio bearer;

DRB: Data Radio Bearer;

SRB: Signaling Radio Bearer;

PDU: Protocol Data Unit;

SDU: Service Data Unit;

V2X: Vehicle-to-Everything;

NAS: Non-Access Stratum.

In the present invention, a network, a base station, and a RAN may be used interchangeably. The network may be a Long Term Evolution (LTE) network, a new RAT (NR) network, an enhanced Long Term Evolution (eLTE) network, or another network defined in a subsequent evolved version of the 3GPP.

In the present invention, user equipment (UE) may refer to an NR device that supports an NR sidelink relay function as described in the background, may also refer to an NR device that supports an NR sidelink relay architecture, and may also refer to an NR device or an LTE device of another type.

In the present invention, sidelink and PC5 may be used interchangeably, and an RLC channel, an RLC entity, and an RLC bearer may be used interchangeably. In addition, PC5 is used for relay operations herein, and can therefore also be replaced with relay.

Hereinafter, a description will be given of related art of the present invention.

### System Information Block 1 (SIB1)

Each cell broadcasts system information, including SIB1. SIB1 includes information such as a cell identity, serving cell configuration information, and access prohibition permission, and provides information indispensable for a UE to perform communication within a cell. The content of SIB1 will be updated, and the UE needs to promptly acquire the updated SIB1, so as to obtain an effective service.

Generally, the UE may directly obtain SIB1 of a cell in which it is located and the updated SIB1 from a base station on an Uu interface. However, when a remote UE is connected to the base station only via a relay UE, it means that the signal quality on the Uu interface is poor. Thus, once SIB1 is updated, the relay UE needs to promptly deliver it to the remote UE.

After obtaining the latest SIB1, the UE stores SIB1, submits some information therein to an upper layer, and then uses serving cell configuration information and other information included in SIB1. These operations may be referred to as applying SIB1.

### Single-Path and Multi-Path Communication

A remote UE may be in communication connection with a base station via a relay UE, and such a connection may be referred to as an indirect connection. The remote UE may operate in a mode in which there is only an indirect connection, and such a mode may be referred to as a single-path communication mode.

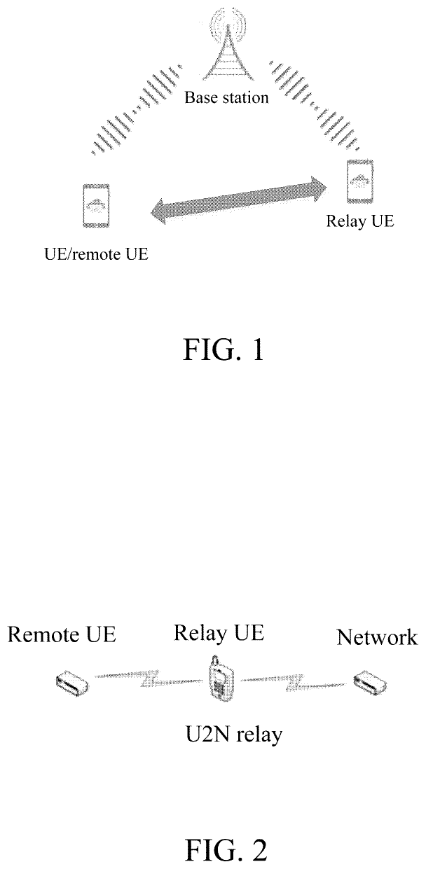

As shown in FIG. 1, a UE and a base station may also communicate with each other via a direct connection and an indirect connection. The UE may be configured to simultaneously operate in a communication mode with a direct connection and an indirect connection, and such a communication mode may be referred to as multi-path (MP) communication or communication with multiple paths. A path of the direct connection may be referred to as a direct path, and the direct path may use a Uu interface to perform communication. A path of an indirect connection may be referred to as a relay path or an indirect path. On the indirect path, the remote UE communicates with the base station via the relay UE. The relay UE and the base station may communicate with each other by using a Uu interface, and the remote UE and the relay UE may communicate with each other using other connection modes such as a PC5 connection or a Wi-Fi connection.

A path corresponding to a direct connection is a direct path, and a path corresponding to an indirect connection is an indirect path. In the case of multiple paths, one of the multiple paths may be defined as a primary path, and paths other than the primary path are secondary paths. The primary path may be a direct path or an indirect path. When the primary path is a direct path, a secondary path is an indirect path. When the primary path is an indirect path, a secondary path is a direct path.

It should be noted that the UE may also communicate directly with the base station. Such a mode is referred to as a direct connection, and is also a single-path operating mode. The UE may operate solely in a direct connection mode. In this mode, there is no relay UE, and accordingly, such a UE cannot be referred to as a remote UE.

It can be seen that the remote UE is relative to the relay UE. A remote UE is present only in a single-path or multi-path scenario in which a relay UE is present, and for a single-path scenario in which no relay UE is present, for example, a direct connection, the UE cannot serve as a remote UE.

The direct connection and the direct path are interchangeable herein. The indirect connection, the relay path, and the indirect path are interchangeable.

The expressions “operating in the multi-path mode” and “configured with multi-path” are interchangeable herein.

Multi-path communication is also interchangeable herein with multi-connection communication or communication with multiple connections.

### Proximity Services (ProSe) Communication Between UEs (UE to UE Communication or U2U Communication)

A UE and a UE may be wirelessly connected to each other by using a proximity services communication means, so as to achieve transmission of data or signaling. The proximity services communication means mentioned herein primarily refers to a sidelink connection, or a Wi-Fi connection, or another connection means. A sidelink connection-based reference point between a UE and a UE is referred to as PC5, and therefore a sidelink-based connection between the UEs may be referred to as a PC5 connection. Sidelink connection and PC5 connection are interchangeable herein. Such a PC5 connection may be identified by a pair of Layer-2 identities (IDs), typically including a source Layer-2 identity (ID) and a destination Layer-2 identity (ID). Such a PC5 connection may be simply referred to as a PC5 connection, a sidelink connection, or the like for or corresponding to a certain destination.

### UE-to-Network Relay (U2N Relay)

As shown in FIG. 2, the left side is a remote UE, the middle is a relay UE, and the right side is a network. The remote UE and the relay UE may be connected to each other via the aforementioned PC5 interface, or Wi-Fi, or another connection means. The PC5 connection is mainly used as an example herein. The relay UE and the network may be connected via a Uu interface. The relay UE relays and forwards signaling and data between the remote UE and the network/base station.

### Uu Interface

A wireless communication interface between a UE and a base station. The UE may communicate with eNB over the Uu interface by using an E-UTRAN. The UE may also communicate with gNB over the Uu interface by using NR.

### Signal Radio Bearer (SRB) and Split SRB

During communication between the UE and the base station, the SRB is used to bear signaling. The UE encapsulates, via a Uu PDCP layer, data of messages to the network for air interface RRC connection setup, re-establishment, resume, etc., and then submits the same to a Uu RLC entity to be further encapsulated, borne on a Uu RLC channel, and submitted downwards layer by layer via Uu-MAC and Uu-PHY. Conversely, an RRC message transmitted by the network to the UE also arrives at the UE via the SRB. Such an SRB may be referred to as an SRB via a direct connection or an SRB via a direct path. In a multi-path configuration, such an SRB may be referred to as a direct SRB, and may also be referred to as a direct bearer.

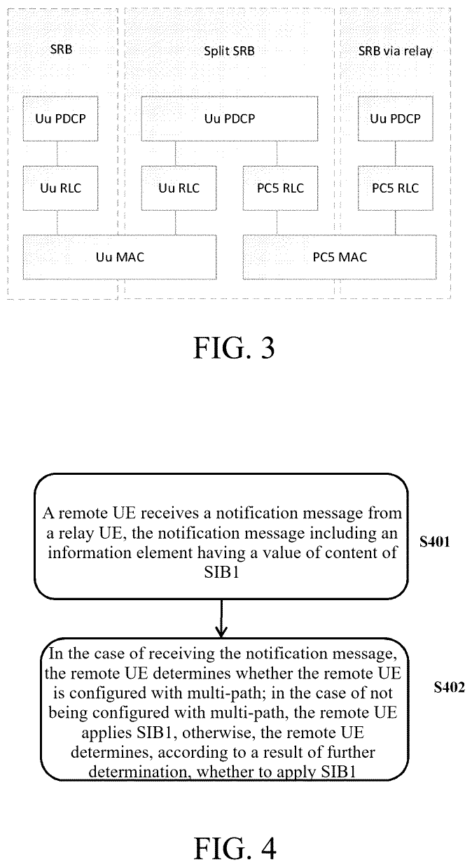

In the multi-path configuration, the UE may be configured with a multi-path (MP) split SRB (which is simply referred to as a split SRB herein), the protocol structure of which is shown in FIG. 3, and a PDCP entity is associated with at least one Uu RLC entity and at least one PC5 RLC entity. After the Uu PDCP layer encapsulates data, the UE may submit the encapsulated data to the Uu RLC entity or the PC5 RLC entity according to a submission rule. If the data is submitted to Uu RLC, processing is the same as that in the case of the SRB. If the data is submitted to PC5 RLC, the data is borne on a PC5 RLC channel after further encapsulation, submitted downwards layer by layer via PC5-MAC and PC5-PHY, and finally transmitted to the base station/network via a relay path. If the data is submitted to Uu RLC, as in the case of the SRB, the data is finally transmitted to the base station/network via a direct path. Such a split SRB may be referred to as a multi-path split SRB configured on a multi-path, or a split SRB via relay, or a split bearer. In a PDCP layer, a PDCP entity may be configured with a primary path, and if the primary path of the PDCP entity corresponds to a relay or an indirect connection, data is generally submitted to the PC5 RLC entity. Conversely, if the primary path corresponds to a direct connection, data is generally submitted to the Uu RLC entity. Only when arriving data exceeds a certain threshold is a part of the data submitted to an RLC entity corresponding to a secondary path. The PDCP entity may also be configured to be in a duplication mode, in which the PDCP layer, after encapsulating the data, generates identical PDCP PDUs to transmit same to the Uu RLC entity and the PC5 RLC entity associated therewith, respectively.

In addition, the PC5 RLC entity associated with the PDCP entity in the protocol structure in FIG. 3 may additionally be associated with an SRAP entity for routing data. That is, a data packet distributed by the PDCP entity to the PC5 RLC entity may first be transmitted to the PC5 SRAP entity associated with this PRC RLC entity, and then transmitted to the PC5 RLC entity after routing information is added.

In the multi-path configuration, the UE may be further configured with an SRB via relay, which may also be referred to as an indirect SRB. The protocol structure thereof is as shown in FIG. 3. After the Uu PDCP layer encapsulates data, the encapsulated data is submitted to a PC5 RLC entity to be further encapsulated, borne on a PC5 RLC channel, submitted downwards layer by layer via PC5 MAC and PC5 PHY, transmitted to relay UE, and then forwarded to the network/base station. Conversely, an RRC message transmitted by the network to the UE may also arrive at the UE via an SRB via relay via the relay UE. Such an SRB via relay may also be referred to as an SRB via a relay path or an SRB via an indirect connection, or an indirect bearer.

Similarly, a data radio bearer (DRB), also referred to as a data bearer, is used to bear data, and an operating mode thereof is the same as that of the SRB, and the DRB may also be configured as a direct DRB, an indirect DRB, or an MP split DRB. The description will not be provided again here.

According to contents that are borne, signal radio bearers (SRBs) may be divided into the following types:

SRB0: used to bear an RRC message transmitted using a logical channel of a common control channel (CCCH).

SRB1: used to bear an RRC message and a non-access stratum message (NAS) transmitted using a logical channel corresponding to a dedicated control channel (DCCH).

SRB2: a non-access stratum (NAS) message and an RRC message including measurement information transmitted using a logical channel corresponding to a dedicated control channel.

Herein, SRB1 is taken as an example, but is not limited to other SRBs. The SRB hereinafter may also be replaced by a DRB.

The method of the present invention is described below with reference to FIG. 4.

FIG. 4 is a flowchart showing a method performed by a user equipment (UE) according to an embodiment of the present invention. As shown in FIG. 4, the method performed by the UE includes steps S401 and S402.

In step 401, a remote UE receives a notification message from a relay UE, the notification message including an information element having a value of content of SIB1.

In step 402, in the case of receiving the notification information, the remote UE determines whether the remote UE itself is configured with multi-path, and in the case of not being configured with multi-path, the remote UE applies SIB1, and in the case of being configured with multi-path, according to a result of further determination, the remote UE determines whether to apply SIB1.

According to the above method, since the obtained SIB1 is not directly applied when the multiple paths are configured, and whether to apply SIB1 is determined according to the result of the determination, even when communication is performed between the UE and the base station on the basis of the multi-path communication mode, the confusion caused for the UE when determining a serving cell can be avoided, so that the serving cell can be appropriately determined, and the communication quality and the communication efficiency can be improved.

Specific embodiments are provided below to describe a processing method of the present invention.

### Embodiment 1

In the present embodiment, the following steps are included:

Step one: receiving, by a remote UE, a notification message from a relay UE, such as a PC5 RRC message, a Uu interface message transfer message, or a Uu message transfer sidelink message, the message including an information element s1-SIB1-Delivery. This information element has a value of content of SIB1.

Step two: upon receiving the above message, determining, by the remote UE in an RRC connected state, whether the remote UE is operating in a single-path or multi-path mode (or determining whether the remote UE is configured with multi-path).

In one case, if the remote UE operates in a single-path mode, that is, the remote UE is connected to a base station only via an indirect connection (or is not configured with multiple paths), then the remote UE may apply SIB1, namely, perform one or more of the following operations, which may specifically include:
saving SIB1;
submitting a cell identity to an upper layer (above an RRC layer, which may be a non-access layer), wherein the cell identity herein refers to a cell identity included in the content of SIB1;
submitting a tracking area code to an upper layer (above the RRC layer, which may be a non-access layer), wherein the tracking area code herein refers to a tracking area code included in the content of SIB1; and
applying serving cell configuration information included therein.

In one type of situation, the remote UE is operating in the multi-path mode (or the remote UE is configured with multi-path), and the UE performs the following determination:
SRB1 is a direct bearer, an indirect bearer, or a split SRB.
   If SRB1 is an indirect bearer, then the remote UE applies SIB1;
   If SRB1 is a direct bearer, then the remote UE may not apply SIB1, or may ignore the received SIB1, or may also discard SIB1;
   If SRB1 is a split SRB, it is further determined whether a primary path of the split SRB corresponds to a direct connection (or a Uu interface) or an indirect connection (or a relay):
      if SRB1 serves as a split SRB, the primary path of which is an indirect connection (or a relay), then the remote UE applies SIB1; and
      if SRB1 serves as a split SRB, the primary path of which is a direct connection (or a Uu interface), then the remote UE may not apply SIB1, or may ignore the received SIB1, or may also discard SIB1.

### Embodiment 2

Embodiment 2 differs from Embodiment 1 in respect of step two.

Step one: is the same as step one in Embodiment 1.

Step two: upon receiving the above message, determining, by the remote UE in an RRC connected state, whether the remote UE is operating in a single-path or multi-path mode (or determining whether the remote UE is configured with multi-path).

In one case, if the remote UE operates in a single-path mode, that is, the remote UE is connected to a base station only via an indirect connection (or is not configured with multiple paths), then the remote UE applies SIB1.

In one type of situation, the remote UE is operating in the multi-path mode (or the remote UE is configured with multi-path), and the UE determines whether a primary path in the multi-path is an indirect connection:
if the UE is configured with the multi-path operating mode, and the primary path therein is an indirect connection (or the non-primary path is a direct connection), then the remote UE applies SIB1;
if the UE is configured with the multi-path operating mode, and the primary path therein is a direct connection (or the non-primary path is an indirect connection), then the remote UE may not perform the above operation, that is, the remote UE does not apply SIB1, or ignores the received SIB1, or may discard SIB1.

The definition of the primary path in the above determination may include, but is not limited to, the following modes:

Mode 1: the primary path may refer to a path used by the UE when setting up or resuming an RRC connection with a base station/network side.

For example, when setting up the RRC connection with the base station/network side, the UE is in a direct connection mode, and then, under the configuration of the network side, the UE adds an operating path of an indirect connection, thereby implementing a multi-path operating mode. In such a case, the primary path is a direct connection, and accordingly, when the UE is subsequently configured with multi-path, the non-primary path (or referred to as secondary path) may be an indirect connection.

As another example, when setting up the RRC connection with the base station/network side, the UE is in an indirect connection mode, that is, the UE sets up a connection with the network side via relay UE, and then, under the configuration of the network side, the UE adds an operating path of a direct connection, thereby implementing a multi-path operating mode. In such a case, the primary path is an indirect connection. Accordingly, the secondary path may be a direct connection when the UE is subsequently configured with multi-path.

Mode 2: the primary path may also refer to a path used by the UE when re-establishing an RRC connection with the base station/network side.

Mode 3: when the UE is configured with multiple paths by the network side, the network side further indicates which one of the multiple paths is the primary path and which one is the non-primary path (or referred to as secondary path). According to configuration information of the network side, the UE may determine whether the primary path is a direct connection or an indirect connection.

Mode 4: after the UE determines a primary cell (Pcell), a path corresponding thereto is a primary path, and the other paths are secondary paths.

### Embodiment 3

Unlike the foregoing embodiments, in the present embodiment, to avoid invalid SIB1 delivery, the relay UE will not transmit a Uu Message Transfer Sidelink message to the remote UE in a specific case.

Step one: receiving, by the relay UE, SIB1 from the base station or the network side, wherein this SIB1 may be an updated SIB1.

Step two: after receiving the updated SIB1, for a remote UE connected to the relay UE, determining, by the relay UE,

whether SRB1 is configured on an indirect connection via the relay UE.

If SRB1 is configured, the relay UE sets the content of the Uu Message Transfer Sidelink message to include the information of SIB1, i.e., include the aforementioned information element s1-SIB1-Delivery, and then the relay UE submits the Uu Message Transfer Sidelink message to a lower layer for transmission.

SRB1 configured here may be an indirect bearer or a split SRB.

If SRB1 is not configured, the relay UE will not execute the above operation.

The present embodiment may be used in combination with the foregoing embodiments, or may be used alone.

### Embodiment 4

Embodiment 4 differs from Embodiment 3 in respect of step two.

Step one: is the same as step one in Embodiment 3.

Step two: after receiving the updated SIB1, for the remote UE connected to the relay UE, determining, by the relay UE,

whether information related to serving as an indirect path is indicated to the relay UE.

If the information related to serving as an indirect path is not indicated to the relay UE, and the relay UE may consider that the remote UE connected to the relay UE operates in a single-path mode, then the relay UE may set the content of the Uu Message Transfer Sidelink message to include the information of SIB1, i.e., include the aforementioned information element s1-SIB1-Delivery, and then the relay UE submits the Uu Message Transfer Sidelink message to a lower layer for transmission.

If the information related to serving as an indirect path is indicated to the relay UE, and the relay UE may consider that the remote UE connected to the relay UE operates in a multi-path mode, then the relay UE will not perform the above operation.

Preferably, if the information related to serving as an indirect path is indicated to the relay UE, and the relay UE serves as a primary path, the relay UE may set the content of the Uu Message Transfer Sidelink message to include the information of SIB1, i.e., include the aforementioned information element sl-SIB1-Delivery, and then the relay UE submits the Uu Message Transfer Sidelink message to a lower layer for transmission.

In the above operation, how the information related to serving as an indirect path is indicated to the relay UE may be implemented in a mode which is not limited to the following modes.

Mode 1: during the process of setting up a PC5 connection between the remote UE and the relay UE or after the setup of the connection, the remote UE indicates to the relay UE to perform path addition or requests the relay UE to use the connection as an indirect path. Optionally, it may be further indicated as a primary path.

Mode 2: when the base station transmits configuration information to the relay UE, the relay UE is indicated as an indirect path, or the connection between the relay UE and the remote UE is configured as an indirect path in the configuration information. Optionally, the connection between the relay UE and the remote UE may be further indicated as a primary path.

### Embodiment 5

Considering that some relay UEs only support a single-path relay function, while some relay UEs also support a multi-path relay operation, how to distinguish between the two types of UEs is also a problem that needs to be solved.

To distinguish between the two types of UEs, an implementation manner is that a relay UE supporting the multi-path relay function may include indication information in a Discovery message distributed or broadcast by the relay UE to indicate that the relay UE supports path addition or a multi-path operation.

Such indication information may be indicated by means of a specific information element. For example, an information element name is set to multi-path, a value of which is set to true or 1, and then it is identified that path addition or a multi-path function is supported.

Such indication information may also be implemented in an implicit manner. For example, a specific logical channel is used for the relay UE to transmit the Discovery message, wherein the relay UE supports the multi-path relay function. For example, a relay UE supporting only the single-path relay function transmits the Discovery message on an SL-SRB having a logical channel identity of 58 and a corresponding SL-SRB name of SL-SRB4. A relay UE supporting the multi-path relay function may transmit the Discovery message on an SL-SRB having a logical channel identity of 55 (or other unoccupied logical channel identities) and a corresponding SL-SRB name of SL-SRB5.

Then, the remote UE may determine, according to the logical channel identity corresponding to the received Discovery message, whether the relay UE supports only the single-path relay function or may support the multi-path relay function. For example, when the received Discovery message is associated with the logical channel identity 55, the remote UE may determine that the relay UE transmitting the Discovery message supports the multi-path relay function. When the received Discovery message is associated with the logical channel identity 58, the remote UE may determine that the relay UE transmitting the Discovery message only supports the single-path relay function.

In addition to identifying the type of the relay UE according to the Discovery message, or after identifying the type of the relay UE in other manners, the remote UE may also indicate the type information in a measurement report to the base station or the network side when generating the report. For example, in the generated measurement report, when the information of a candidate relay UE is reported, in addition to indicate the UE identity of the relay UE, it may also be indicated that the relay UE supports the multi-path relay operation. In this way, after receiving the measurement report, the base station may select a relay UE in which the multi-path relay function is supported, as a candidate target for a subsequent indirect path or path addition.

Another reporting manner may be that when performing measurement configuration for the UE, the base station indicates the measurement configuration of multi-path relay. Then, when the measurement report is generated, UE identities of relay UEs that meet a condition and support the multi-path relay function are indicated in a measurement result corresponding to the measurement configuration of multi-path relay. The UE identifies the type of the relay UE in the foregoing manner.

Here, “supporting the multi-path relay function” mainly refers to a capability of supporting path addition or serving as an indirect path.

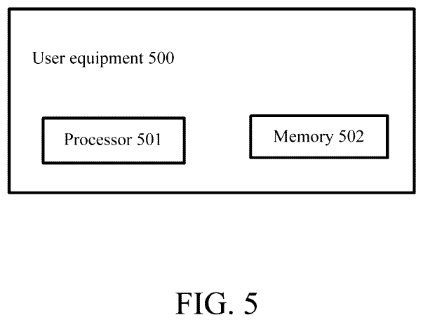

FIG. 5 is a simplified structural block diagram of user equipment according to the present invention.

As shown in FIG. 5, the user equipment 500 includes at least a processor 501 and a memory 502. The processor 501 may include, for example, a microprocessor, a microcontroller, an embedded processor, and the like. The memory 502 may include, for example, a volatile memory (for example, a random access memory (RAM)), a hard disk drive (HDD), a non-volatile memory (for example, a flash memory), other memory systems, or the like. The memory 502 has program instructions stored thereon. When the instructions are run by the processor 501, one or several steps in the processing method for a UE of the present disclosure may be performed.

The method and related equipment according to the present disclosure have been described above in conjunction with preferred embodiments. It should be understood by those skilled in the art that the method shown above is only exemplary, and the above-described embodiments can be combined with one another as long as no contradiction arises. The method of the present invention is not limited to the steps or sequences illustrated above.

The user equipment shown above may include more modules, for example, may also include modules that can be developed or will be developed in the future and can be used for base stations, MMEs, or UEs, and so on. Various identifiers shown above are only exemplary, not for limitation, and the present disclosure is not limited to specific information elements serving as examples of these identifiers. Those skilled in the art could make various alterations and modifications according to the teachings of the illustrated embodiments.

It should be understood that the above embodiments of the present disclosure may be implemented through software, hardware, or a combination of software and hardware. For example, various components in the base station and user equipment in the above embodiments can be implemented by multiple devices, and these devices include, but are not limited to: an analog circuit device, a digital circuit device, a digital signal processing (DSP) circuit, a programmable processor, an application-specific integrated circuit (ASIC), a field-programmable gate array (FPGA), a complex programmable logic device (CPLD), and the like.

The program running on the device according to the present invention may be a program that enables the computer to implement the functions of the embodiments of the present invention by controlling a central processing unit (CPU). The program or information processed by the program may be temporarily stored in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions may be achieved by reading programs recorded on the recording medium and executing the programs by a computer system. The phrase “computer system” herein may be a computer system embedded in the device, which may include operating systems or hardware (e.g., peripherals). The phrase “computer-readable recording medium” may refer to a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed by circuits (for example, monolithic or multi-chip integrated circuits). Circuits designed to execute the functions described in this description may include general-purpose processors, digital signal processors (DSPs), application-specific integrated circuits (ASICs), field-programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioners, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1-10. (canceled)

11. A remote user equipment (UE), comprising:
a processor; and
a memory in electronic communication with the processor, wherein instructions stored in the memory are executable to:
receive a Discovery message from a relay UE, the Discovery message including an indication to indicate support of a multi-path operation,
set, in a measurement report to network, a relay UE identity to indicate the relay UE and the indication to indicate the support of the multi-path operation for the relay UE.

12. A method performed by a remote user equipment (UE), comprising:
receiving a Discovery message from a relay UE, the Discovery message including an indication to indicate support of a multi-path operation,
setting, in a measurement report to network, a relay UE identity to indicate the relay UE and the indication to indicate the support of the multi-path operation for the relay UE.
